(19) United States
(12) Patent Application Publication
(10) Pub. No.: US 2015/0339934 A1
(43) Pub. Date: Nov. 26, 2015

(54) CRASHABLE INFLATABLE

(71) Applicants: Joanne Douglas, Westlake, OH (US); Albert Salzer, Westlake, OH (US)

(72) Inventors: Joanne Douglas, Westlake, OH (US); Albert Salzer, Westlake, OH (US)

(21) Appl. No.: 14/287,009

(22) Filed: May 24, 2014

(51) Int. Cl. G09B 1/32

(52) U.S. Cl. CPC G09B 1/32

(57) ABSTRACT

An inflatable device configured to be used in connection with vehicle testing and demonstrations. The inflatable comprises one or more inflatable membranes for enclosing air or other gases to form any number of possible shapes. One or more interior walls having holes for adequate air flow, provide added structural support for the inflatable. One or more bladders attached to a bottom of the inflatable are used to provide added stability for the inflatable, and to prevent unwanted movement. One or more light-emitting devices may be mounted to the inflatable to simulate a vehicle's lights for the purpose of testing or demonstrating collision avoidance systems. Materials chosen to simulate traffic obstacles may be removably mounted onto the inflatable or a sleeve enclosing the inflatable to simulate such traffic obstacles.

### BACKGROUND OF THE INVENTION

1. Technical Field

The present invention relates to a system and method for a crashable inflatable.

2. Description of Related Art

Inflatables are used for advertising and to attract attention. There is a need for a more robust, sturdy, and crashable inflatable.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side perspective view of a crashable inflatable in one embodiment;

FIG. 2 is a top perspective view of a crashable inflatable in one embodiment;

FIG. 3 is a bottom perspective view of a crashable inflatable in one embodiment;

FIG. 4 is a perspective view of a crashable inflatable with a sleeve in one embodiment.

FIG. 5 is a front perspective view of a crashable inflatable with having wirelessly actuated light sources mounted thereon;

FIG. 6 is a side perspective view of the wirelessly-actuated light source mounted on a crashable inflatable as shown in FIG. 5; and

FIG. 7 is a block diagram showing components of the wirelessly actuated light source as shown in FIG. 5 and FIG. 6, and a remote wireless transmitter for actuating said light source.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

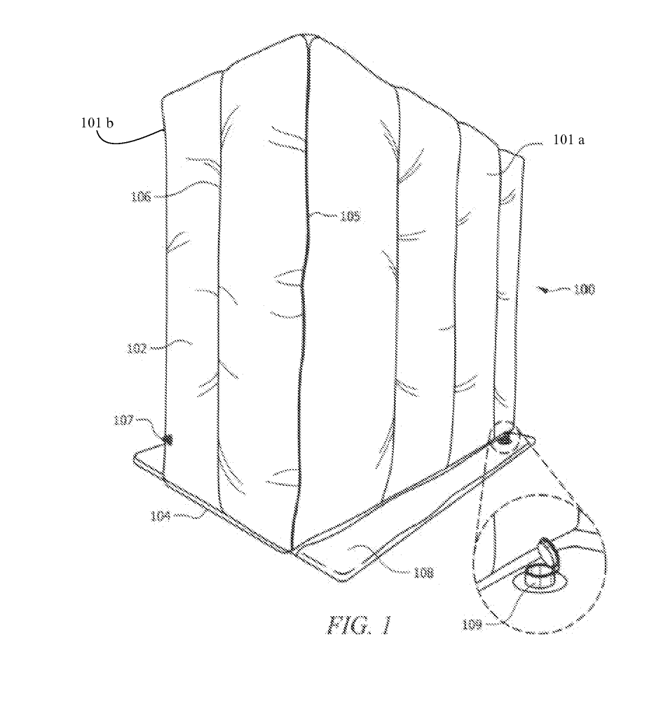

FIG. 1 is a side perspective view of a crashable inflatable in one embodiment. An inflatable is an object which can be inflated with air. Inflatables include balloons, or other similar devices, which can be inflated with and contain air, nitrogen, helium, argon, mixed gases and any other gases known in the art to be suitable for inflation of such devices. In one embodiment the inflatable is air-tight meaning the inflatable, once inflated, will hold the air without leaking air for greater than one day.

A crashable inflatable is an inflatable which can be hit with a standard sedan automobile at speeds greater than 20 miles per hour and maintain its desired shape and without leaking air. In one embodiment a crashable inflatable can be hit with a standard sedan automobile at speeds greater than 40 miles per hour.

As will be discussed in more detail below, in one embodiment the crashable inflatable is used to demonstrate braking potential of a vehicle. Thus, the crashable inflatable, in such embodiments, will occasionally be hit with a vehicle. Because of the features of the crashable inflatable, in one embodiment, upon being hit by a vehicle, the crashable inflatable moves as a single unit. Thus, the crashable inflatable 100 glides upon the ground and the entire unit moves away in response to getting hit by a vehicle. This is in stark contrast to an anchored inflatable in which the top portion of the inflatable would fold leaving the anchored base in place to be run over by the vehicle, and irreparably damaging the inflatable. The components of a crashable inflatable 100 will be discussed in reference to one embodiment. This is for illustrative purposes only, and should not be deemed limiting.

The crashable inflatable 100 can comprise virtually any material. The crashable inflatable 100 can comprise any material which typical inflatables comprise such as, for example, nylon fabric coated with polyvinyl-chloride (“PVC”). Such materials serve as a membrane in which gas is enclosed and held. In one embodiment the crashable inflatable 100 comprises nylon fabric. In one embodiment the fabric comprises Nylon 200 Denier. In one embodiment the fabric comprises nylon fabric coated with PVC. The PVC increases the structural rigidity of the fabric and helps the crashable inflatable maintain its desired shape. The PVC coating also gives the nylon the ability to contain air or whatever other gas is used to inflate the inflatable. Those skilled in the art will recognize that the thickness of the PVC coating and nylon may be varied depending upon the application of the inflatable. One example of a PVC-coated nylon fabric that may be utilized in one embodiment of the crashable inflatable is Aeron 27 branded material made by Flexfirm Products, Inc. of South El Monte, Calif.

In one embodiment the crashable inflatable 100 comprises 7 ounce fabric. 7 ounce fabric refers to fabric of which one square yard weighs 7 ounces. 7 ounce fabric has been found to be sufficiently resilient to be used in a crashable inflatable 100. Thicker and heavier fabric, such as 8, 10, 12, or 14 (or higher) ounce fabric can also be utilized. However, such fabric will increase the weight and cost of the crashable inflatable 100.

Returning to FIG. 1, the crashable inflatable 100 comprises a front face side 101, a rear face side, two shorter sides 102, a top 103 (not depicted in FIG. 1), and a bottom 104. The crashable inflatable 100, as depicted, comprises a rectangular cross-section, though other cross-sections, including circular, square, or other polygons, can also be utilized. In fact, alternate embodiments of the crashable inflatable may be shaped in any other manner desired such as, for example, in the shape of a tree, person, structure, or animal. The size of the crashable inflatable 100 can vary depending on the desired application. In one embodiment, the front side 101 is sized to replicate a view of a vehicle. In one embodiment the front side 101 is sized to replicate the back view of a vehicle.

The crashable inflatable 100, in embodiment has a length of between about 50 inches to about 150 inches. The length is measured as the length of the front side 101. In one embodiment the crashable inflatable 100 has a height of between about 36 to about 90 inches as measured from the bottom 104 to the top 103. In one embodiment the crashable inflatable 100 has a width, as measured as the distance between front faces 101, of between about 1 foot and about 5 feet. In one embodiment the crashable inflatable 100 is about 75 inches in length, 63 inches tall, and 36 inches wide. These dimensions are for illustrative purposes only and should not be deemed limiting.

In one embodiment upper portion of the crashable inflatable comprises the top 103, the two front and back sides 101, and the left and right sides 102. The lower portion of the crashable inflatable comprises the bottom 104. In one embodiment the upper portion comprise the same material whereas the lower portion comprises a dissimilar material. In one embodiment the lower portion comprises a thicker material than the upper portion. For example, in one embodiment the upper portion comprises a 7 ounce fabric whereas the lower portion comprises a 14 ounce fabric. As will be discussed, the bottom 104, in one embodiment, rests upon the ground. The ground may comprise grass, concrete, asphalt, or other rough material. When impacted with a vehicle, the bottom 104 will scrape or glide across the ground. Accordingly, in one embodiment, the bottom 104 comprises a strong material which can tolerate the friction and scrapes associated with the ground.

The bottom 104 can comprise a flexible fabric as previously described. Or, the bottom 104 can comprise a rigid material such as plastic, polymers, metals, wood, rubber and other materials that are known in the art as being suitable for such purposes. One advantage of the bottom 104 comprising a flexible fabric is that the entire crashable inflatable 104 is collapsible and easily stored. This will be discussed in more detail below herein. In alternate embodiments, a magnetized metal or alloy may be mounted to the bottom of the inflatable, such that when used in conjunction with an electromagnet anchored to the ground and connected to a switch, a manner of selectively holding and releasing the inflatable may be realized. Such use of an electromagnet would provide for anchoring of the inflatable until such time as it was desired that it not be anchored (for example, when the inflatable is to be used in demonstrating collision avoidance systems).

In one embodiment the crashable inflatable 100 comprises a reflective color, such as a white material. As depicted in FIG. 1, the upper portion comprises a white material. A reflective material, such as white, reflects heat. Because the crashable inflatable 100 is often stored upon a black asphalt, the crashable inflatable 100 is often subjected to drastic temperature conditions. Because air, like other fluids, expands and contracts according to temperature, methods reducing temperature swings will help the crashable inflatable 100 maintain its desired shape. A reflective material helps minimize the temperature effects.

Located on the lower left of the left side 102 is an air valve 107. The air valve 107 can comprise any valve which allows air to be added and removed from the crashable inflatable 100. In one embodiment the air valve 107 is located on the side to avoid direct contact with a vehicle. While depicted as being located on the side 102, this location should not be deemed limiting as the air valve 107 can be located on anywhere on the crashable inflatable 100.

Coupled to the lower portion is the bladder 108. As depicted, the bladder 108 is flat. The bladder 108 as used herein, is a fillable balloon or pocket coupled to a lower portion which helps to anchor the crashable inflatable 100. The bladder 108 adds weight to the lower portion of the crashable inflatable 100. The bladder 108 can comprise an inflatable which can be filled with a weighted item, such as water, gel, sand, dirt, gravel, plastic beads, heavy foam, etc. Virtually any weighted object can be inserted into the bladder 108 to add weight to the crashable inflatable 100. As depicted the bladder comprises a water valve 109 through which water can be added or removed from the bladder 108.

In one embodiment the crashable inflatable 100 comprises two bladders: one on the front side 101 and on the back side 101. It has been discovered for embodiments utilizing water that having two bladders 108 as opposed to one larger bladder 108 minimizes the effect of wind on the bladder 108. When using a large single bladder 108, the wind can cause the water in the bladder 108 to slosh, making the crashable inflatable 100 undesirably move with the wind. This effect is significantly reduced with two bladders 108 because the volume in each bladder 108 is reduced by half. Thus, even if the wind causes the water in each bladder 108 to slosh, because there are two smaller bladders 108, the force of the water in each bladder 108 is reduced. Further, having two bladders 108 on opposing faces allows the front bladder 108, for example, to cancel the forces on the back bladder 108. Thus, for example, water in the front bladder 108 sloshes forward while water in the back bladder 108 sloshes backward. While an embodiment has been described using two bladders 108 on the front and back faces, this is for illustrative purposes and should not be deemed limiting. In other embodiments, for example, the left or right sides, or both, will comprise a bladder 108. Further, in other embodiments the front and/or back sides will each have more than two bladders 108.

The bladders 108, as noted, anchor the crashable inflatable 100 and prevent the crashable inflatable 100 from undesirably being pushed by the wind. However, in one embodiment the bladders 108 do not permanently anchor the crashable inflatable 100 such that the crashable inflatable 100 can still move when hit by a vehicle.

The size and number of the bladder 108 is dependent upon the size and geometry of the crashable inflatable. In one embodiment wherein the crashable inflatable 100 is about 75 inches in length, 63 inches in height, and about 36 inches wide, there are two bladders 108 located at the front and back sides 101 which run the entire length of the front side 101. The bladders 108 are about 4 inches in diameter when filled, and hold about 34 pounds of water each (about 8 gallons). In alternate embodiments, the bladders could be sized smaller or larger, depending upon the application for which they are sought.

As seen in FIG. 1, the front face 101 and the left side 102 intersect at an exterior seam 105. As depicted, the exterior seam 105 is a seam located on the exterior side of the inflatable located at any intersection of any side. Thus, there is an exterior seam 105 located at the intersection of the front side 101 and the left side 102, as well as the intersection of the front side 101 and the top side 103, etc. The exterior seam 105 is the seam at which two sides are joined together. The exterior seam 105 serves several purposes. First, it adds to the structural rigidity of the crashable inflatable 100. Second, it serves to prevent leaks and thus maintain the air within the inflatable. Even further, the exterior seam serves to give the inflatable a more defined corner, which aids in displaying visual media on the inflatable.

Virtually any method or device known in the art which can be used to join two materials or fabrics can be utilized. In one embodiment a seam sealer is used to create the exterior seam 105. In other embodiments, other methods may be used to join two materials or fabrics to construct the inflatable such as, for example, thermal welding (with a heat gun), tape, glue and other adhesives. In another embodiment seam tape is first used to position adjacent edges. Then, the two edges are sewn together to create a seam. Finally, in one embodiment, the stitching is covered by paint, such as rubberized paint. The rubberized paint adds to the structural strength and helps prevent leaks. Other materials, such as glue or other adhesives, may be utilized to cover stitching in order to prevent leaks and increase the structural strength of the inflatable.

Virtually any sized needle, and any sized thread, can be used to sew the exterior seam 105. In one embodiment a needle sized at 100/16 is utilized, but this is for illustrative purposes only and should not be deemed limiting.

Virtually any type of thread can be utilized, but in one embodiment 16 ounce polymetric bonded polyester thread is utilized. Smaller thread can be used, and smaller thread results in smaller holes which are easier to seal. Those skilled in the art will understand balancing the structural benefit of thicker thread against the sealing benefit of thinner thread for a particular scenario.

As noted, the exterior seams 105 add to the structural strength of the crashable inflatable 100. Further, the exterior seams 105 help maintain the desired shape. Without the exterior seams 105, the crashable inflatable would not maintain the rectangular shape depicted and instead would swell into a sphere or oval shape. Accordingly, the exterior seams 105 provide the crashable inflatable 100 shape.

As depicted there are four approximately vertical exterior seams 105 located at each corner of the crashable inflatable. There are also eight approximately horizontal exterior seams 105, four each located at the perimeter of the top 103 and bottom 104 sides. The number of the exterior seams 105 is dependent upon the shape and cross section of the crashable inflatable.

Also depicted in FIG. 1 are the interior wall seams 106. The interior wall seams are located at the intersection of an interior wall with an exterior wall. As shown, there is one vertical interior wall seam 106 located on the left side 102, and three vertical interior wall seams 106 located on the front side 101. While any number of interior walls may be utilized, or none at all, interior walls are preferably utilized and spaced no more than eighteen inches apart as increased spacing may lead to the undesired rounding of exterior sides of the inflatable.

The interior walls and the interior wall seams 106 provide increased strength and rigidity to the crashable inflatable. Further, they help maintain the desired shape. For example, if the interior wall seam 106 located on the left side 102 were not present, then rather being the relatively flat left side as depicted in FIG. 1, the left side would be curved and rounded.

The interior walls can comprise virtually any material discussed herein. In one embodiment the interior walls comprise the same material as the upper portion of the crashable inflatable 100. Thus, in one embodiment the interior walls comprise the same material as the front side 101.

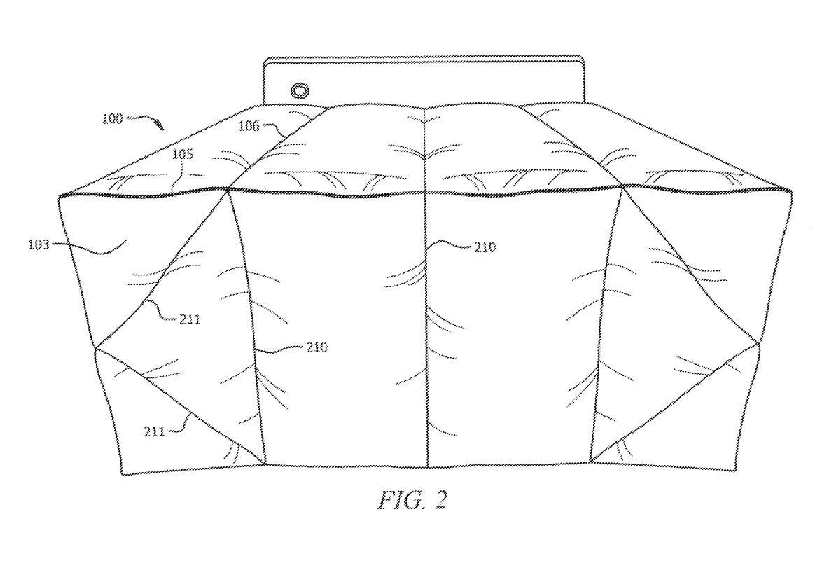

FIG. 2 is a top perspective view of a crashable inflatable in one embodiment. As can be seen, the four exterior seams 105 outline the perimeter of the top side 103. As depicted, the top side 103 comprises the shape of a rectangle.

FIG. 2 also depicts three interior seams 106 which appear vertically in FIG. 2, as well as four angled interior seams 106. As noted, these interior seams 106 couple an external wall with an internal wall. Accordingly, on the internal side of each of these interior seams 106 is an interior wall. Behind and coupled to the three interior seams 106 which appear vertically are three interior straight walls. Behind and coupled to the four interior seams 106 which are angled, are four interior angled walls 211.

The interior walls, in one embodiment, extend from the top side 103 to the bottom side 104. This increases structural rigidity and maintains the desired shape of the crashable inflatable 100. In other embodiments, however, the interior walls do not extend from the top side 103 to the bottom side 104.

The four interior angled walls 211 help maintain and reinforce the shape at the corners. The angled walls 211 make it possible to obtain the four sharp right angles depicted in FIGS. 1 and 2. Without the angled walls 211, the sharp right angles would be replaced by rounded and curved corners.

In one embodiment, the interior walls comprise at least one hole which allows air to pass. Without at least one hole in the interior wall, there would be no way to fill the entire inflatable with air as air could not pass through the interior wall. However, a hole allows air to pass through the interior wall, filling the entire crashable inflatable 100.

The placement of the at least one hole on the interior wall affects the structural strength of the crashable inflatable. Too many holes placed too close to a seam decreased the strength provided by the interior wall and fails to provide the desired shape. Accordingly, in one embodiment the hole is less than one-third of the width of the interior wall. For example, if the interior wall is 3 feet wide, the hole must be one foot in diameter or less. Further, in such a scenario, the holes must be separated by a foot or more. Such limitations prevent the holes from undesirably weakening the interior walls, which would lead to an undesired change in shape of the inflatable.

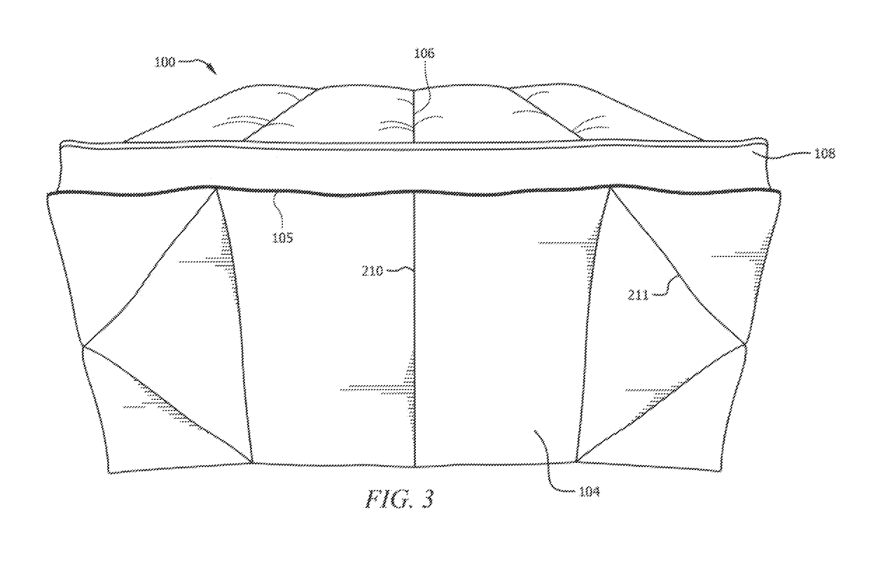

FIG. 3 is a bottom perspective view of a crashable inflatable in one embodiment. It can be seen in FIG. 3, that the bladder 108 is coupled to the bottom side 104. Also visible in FIG. 3 are the interior seams 106 and exterior seams 105 discussed above. As discussed, in one embodiment, the crashable inflatable 100 rests upon the bottom side 104 when the inflatable 100 is fully inflated. Further, as discussed, in one embodiment the bottom side 104 comprises a fabric which is thicker, and more durable, than the fabric on the upper side. This allows the bottom side 104 to be scraped against the ground without ripping. In alternate embodiments, heavy fabric could be utilized to construct other portions of the inflatable, or even the entire inflatable.

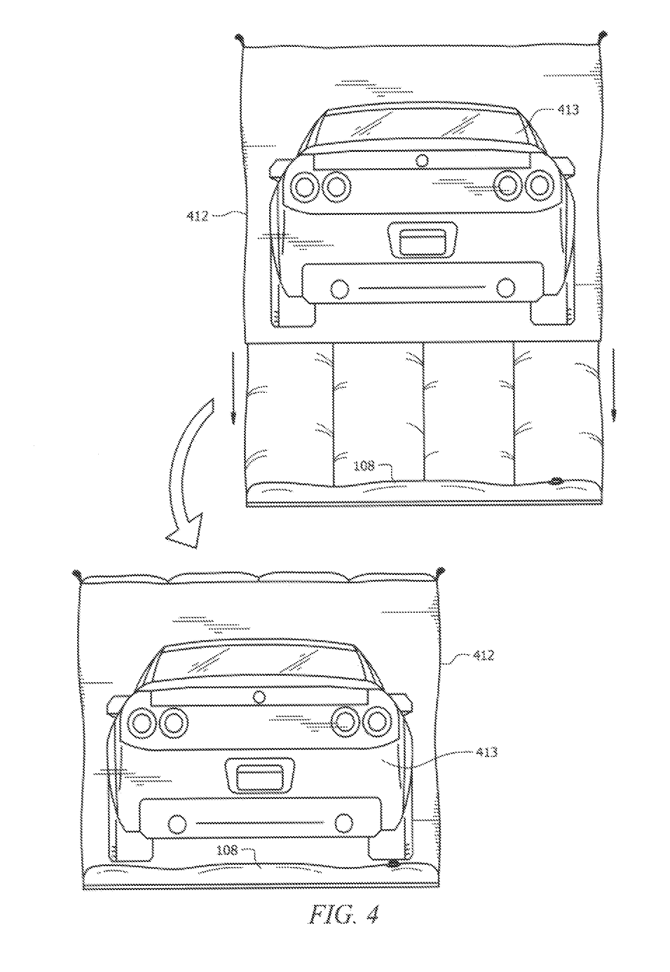

FIG. 4 is a perspective view of a crashable inflatable with a sleeve in one embodiment. The top part of FIG. 4 shows the sleeve 412 in the process of being pulled down over the crashable inflatable 100. The bottom portion of FIG. 4 shows the sleeve 412 covering the crashable inflatable 100. A sleeve 412 is a covering which fits and at least partially covers the crashable inflatable 100. In one embodiment, and as depicted, the sleeve 412 comprises an image 413. As depicted the image 413 comprises the back view of an automobile.

The sleeve 412, in one embodiment, comprises five sides and an open bottom. Such an embodiment can slide down over the crashable inflatable 100. In other embodiments, however, the sleeve 412 only comprises one or more sides which are affixed to the crashable inflatable 100 via mechanical devices such as Velcro, pins, straps, or the like.

A sleeve 412 provides the benefit of changing the image 413. For example, if the crashable inflatable 100 is used in a Ford® branded dealership a first sleeve 412 comprising the image of a Ford® branded vehicle can be utilized. However, a second sleeve 412 comprises the image of a Chevrolet® branded vehicle. Thus, the sleeve 412 provides increased versatility. In alternate embodiments, visual media may be placed directly onto the inflatable without the use of a separate sleeve. For example, in alternate embodiment, visual media (such as an outline of the rear of an automobile) may be printed directly onto at least a portion of the exterior fabric that comprises the crashable inflatable. FIG. 4 also demonstrates an inflated bladder 408. As depicted, the bladder 108 has been filled with water. Thus, while the bladder 108 has been previously depicted as being flat, such as in FIG. 1, FIG. 4 shows the bladder 108 in an inflated embodiment.

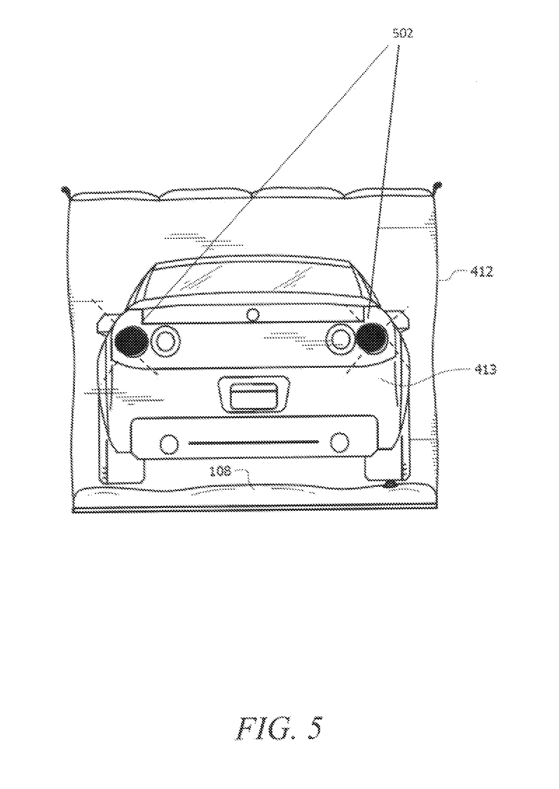

Referring now to FIG. 5, a front perspective view of a crashable inflatable sleeve 412 with having wirelessly-actuated light sources 502 mounted on an exterior face of the inflatable. Certain automobiles are equipped with collision avoidance systems comprising various sensor devices for sensing the proximity of other stationary and moving objects around the automobile. Such collision avoidance systems use the information collected by the sensor(s) to determine whether to actuate braking and other vehicle control systems in order to prevent a collision. One type of sensor used in certain automobile collision avoidance systems is an infrared or other light sensor that is configured to sense the type of light that is emitted from automobile brake lights is being emitted from vehicles that are adjacent to the automobile equipped with the collision avoidance system. The collision avoidance system may utilize information received from the infrared sensor either alone, or in combination with distance measuring sensors (radar, laser, sonar, stereo cameras, etc.) to determine whether a collision with a decelerating automobile is imminent.

One of the uses of the crashable inflatable is to test or demonstrate such collision avoidance systems, as it provides an automobile-like object that may be used to safely test such systems without the risk of damage to the automobile or persons contained within should the collision avoidance system not prevent an actual collision. In alternate embodiments of the crashable inflatable 412 as shown in FIG. 5, one or more wirelessly-actuated light sources are mounted onto the sleeve 413 secured to the sleeve 412 (on an exterior face of the inflatable). The light sources 502 may be activated via a wireless remote (not shown) or other mechanism to illuminate, so as to simulate vehicle brake lights. Thus, when used in conjunction with an automobile or any other vehicle equipped with a collision avoidance system having a light sensor, the crashable inflatable will more realistically simulate actual traffic conditions.

It should be noted that while the embodiments of the crashable inflatable discussed herein have been described in the context of use with automobiles, other alternate embodiments may be utilized in conjunction with all manner of vehicles such as trucks, aircraft, marine vehicles, all-terrain vehicles, etc. In other alternate embodiments, the material used to construct the sleeve or the inflatable may be at least partially comprised of materials (metals, plastics, alloys, rubber, etc.) configured to better simulate materials typically found on vehicle exteriors so as to more optimally simulate such vehicles for the purposes of testing and demonstrating collision avoidance systems. Likewise, in even further alternate embodiments, the material used to construct the sleeve or the inflatable may be at least partially comprised of materials (wood, steel, stone, etc.) configured to better simulate materials typically found on other traffic obstacles (trees, guardrails, road barriers, etc.) that may be encountered by vehicle collision avoidance systems in real world traffic situations. Such materials used to simulate traffic obstacles may be removably mounted onto one or more exterior faces of the inflatable or sleeve using, for example, adhesives or hook and loop fasteners.

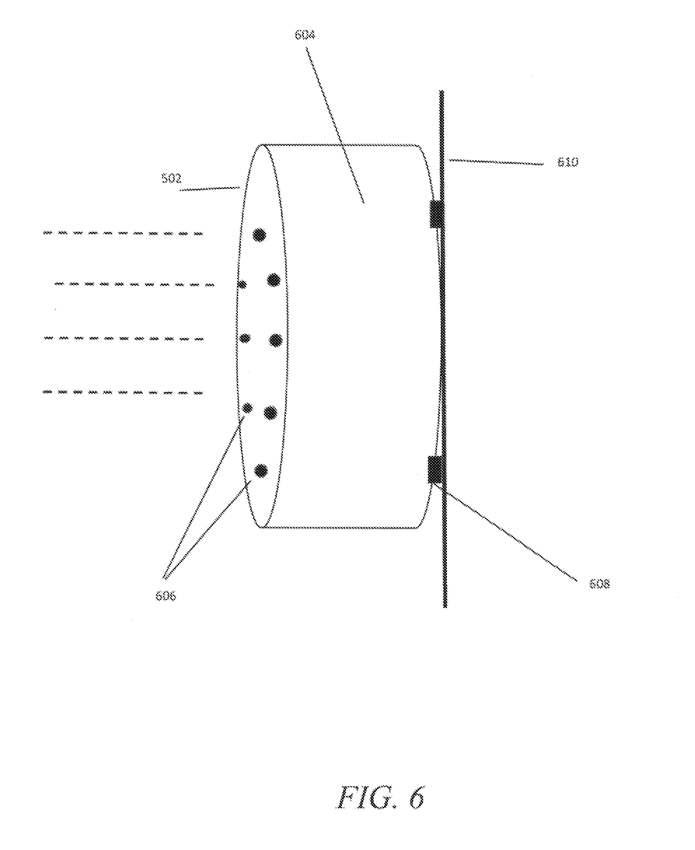

Referring now to FIG. 6, a side perspective view of the wirelessly-actuated light source 502 mounted on a crashable inflatable 610 as shown in FIG. 5. In one embodiment, the one or more light sources 502 comprise a housing 604 containing an array of light-emitting diodes (“LED”) 606 mounted behind a lens as a vehicle tail light is typically constructed. The housing further contains electronic components and a power source for operating the light source. As will be understood by those skilled in the art, the light source may be configured in numerous alternate ways while still providing the desired effect of simulating a vehicle tail light. By way of example, incandescent bulbs mounted behind a red colored lens may be substituted for an LED array in the light source of alternate embodiments. The light source 502 is mounted onto the sleeve 412 via correspondingly mating hook and loop fasteners 608 attached to the housing 604 and the sleeve 610 such that they light sources may be easily mounted and removed from the sleeve. In alternate embodiments, the one or more light sources may be integrated onto the sleeve or the inflatable fabric.

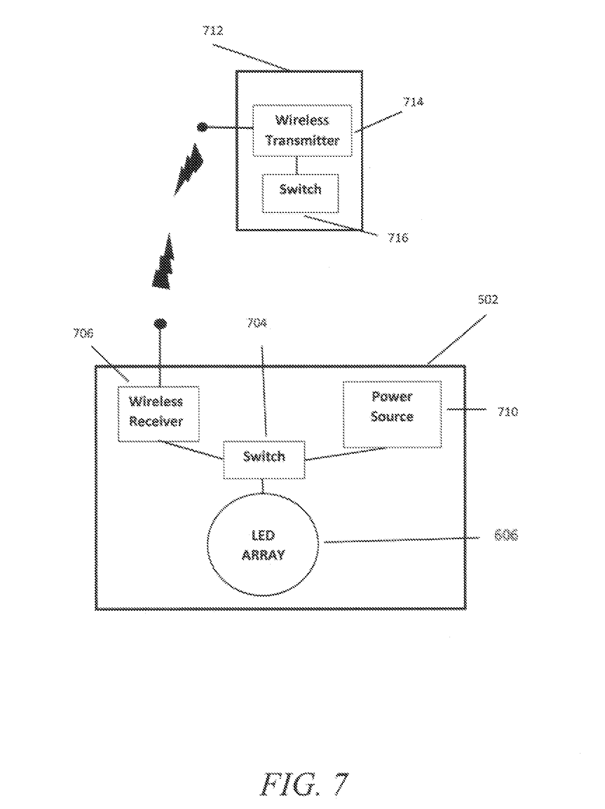

Referring now to FIG. 7, a block diagram showing components of the wirelessly actuated light source 502 as shown in FIG. 5 and FIG. 6, and a remote wireless transmitter switch 712 for actuating said light source. The housing of the one or more light sources 502 contains various electronic systems for actuating and powering said light source. In one embodiment, the light source includes a wireless RF receiver 706 (with antenna) for receiving wireless transmissions containing data for activating a switch 704. A power source 710 such as, for example, batteries, provides power needed to activate the LED array 708. In alternate embodiments, other various components may be utilized to provide for wireless or wired actuation of the light source 502. For example, solar power may be utilized to charge the batteries in alternate embodiments of the light source. In even further alternate embodiments, the light source may be powered by energy harvesting devices that derive energy from such sources as wind energy or kinetic energy.

A remote wireless transmitter switch 712 may be utilized to actuate the light source wirelessly. Thus, when testing or demonstrating an automobile's collision avoidance system, a person may remotely activate the one or more light sources to simulate another vehicle's tail lights (indicating deceleration). The remote switch 712 may comprise a wireless transmitter and a push button switch 716 for activating and deactivating the one or more light sources mounted on the crashable inflatable.

As noted, the crashable inflatable 100 has several uses. One such use is demonstrating braking power or teaching young driver's how to park. In such embodiments a crashable inflatable 100 such as that shown in FIG. 4 is placed in a location, such as a parking lot. A driver can be instructed to drive a certain speed and then press the brakes, for example, to demonstrate braking power. If the driver does not apply the brakes at the required moment, the vehicle will crash into the crashable inflatable 100. When this happens, the front bumper of the vehicle clears the bladder 108 and strikes the front side 101 of the crashable inflatable 100. For the reasons discussed herein, the crashable inflatable 100 has increased structural rigidity and desires to maintain its shape. Accordingly, when the front side 101 of the crashable inflatable 100 is hit with the vehicle, the force of the impact is spread to the entire crashable inflatable 100. Accordingly, the crashable inflatable 100, as a single unit, responds to the force of the car by moving in the opposite direction. Thus, when the front side 101 of the crashable inflatable 100 unit is hit, the entire unit moves. Depending upon the force of the impact, the crashable inflatable 100 may slide along the bottom side 104 or may bounce and fly out of the way. Because of the structural properties discussed herein, even after being impacted at greater than 20 miles per hour, and in some cases greater than 40 miles per hour, the crashable inflatable 100 does not puncture or pop. Instead, the crashable inflatable 100 is not damaged and can be re-positioned and used again.

In one embodiment all six sides of the crashable inflatable 100 comprise a flexible fabric. Accordingly, in one embodiment, after removing the air from the inflatable, and the water or other material from the bladder 108, the crashable inflatable 100 can be folded and/or rolled to fit within a carrier. In one embodiment, the crashable inflatable 100 can be folded to fit within a container with a volume of about one cubic foot.

Virtually any type of pump or air mover can be used to inflate the crashable inflatable 100. Those skilled in the art will understand how to couple a pump with the air valve 107. In one embodiment the pump or air mover is reversible. Thus, the pump, for example, in the reverse direction and pull the air from the crashable inflatable 100.

To inflate the crashable inflatable 100, the inflatable is first removed from the carrier. Then, a pump or other air mover is coupled to the air valve 107. The pump is then engaged, and the crashable inflatable is inflated. Thereafter, water, sand, gel, or other material is added to the bladder 108. Finally, a sleeve 412 is coupled to the crashable inflatable 100. To deflate and remove the crashable inflatable 100, the process is reversed.

The crashable inflatable 100 has several advantages. First, because it is not permanently anchored to the ground, it can serve as a crashable inflatable as previously discussed. Thus, it can be used as a sales aid to demonstrate braking, steering, or parking features in a car. For example, if a vehicle has a parking assist feature, the crashable inflatable 100 can function as vehicles which the parking car must park between, next to, etc. Further, if the car has an automatic brake feature or collision avoidance system, the crashable inflatable 100 can serve as the target which is to be avoided if the brake/avoidance feature is successful. If, however, the brake/avoidance feature is unsuccessful, the crashable inflatable 100 is bumped out of the way by the vehicle as previously discussed without incurring any significant damage such that the crashable inflatable 100 can be reused in additional demonstrations.

Second, the crashable inflatable 100 can be used as a teaching aid to assist in teaching drivers how to park, parallel park, brake, etc.

Third, as noted, in one embodiment the crashable inflatable 100 is collapsible making it easy to store, transport, etc.

Fourth, the bladder 108 system offers additional structural support. This allows the crashable inflatable 100 to be utilized in windy or rainy conditions which are unsuitable for prior art inflatables. Thus, even if the crashable inflatable 100 is not intended to be hit by a vehicle, because of the increased structural rigidity and anchoring system compared to traditional inflatables, the crashable inflatable can be used in windy or rainy conditions. Another advantage of utilizing a bladder system to anchor the inflatable is that it is not necessary to drive stakes or other support structures into the ground, concrete or asphalt adjacent to the inflatable for anchoring purposes.

The crashable inflatable 100 discussed herein can be manufactured in a variety of methods. In one embodiment sheets of fabric are unrolled and cut as desired. In one embodiment the left and right sides and the top sides are one single integral piece. This adds to the structural strength of the inflatable and reduces the number of seams which must be made This arrangement also allows for assembly of the sheets of fabric starting from the top and working downwards, from one end to the other (including interior walls), with the bottom side assembled last.

While the invention has been particularly shown and described with reference to a preferred embodiment, it will be understood by those skilled in the art that various changes in form and detail may be made therein without departing from the spirit and scope of the invention.

1. A crashable inflatable comprising:
a front side opposing a back side;
a left side opposing a right side;
a top side opposing a bottom side;
at least one bladder coupled to said bottom side;
at least one internal wall connecting said top side with said bottom side; wherein
said at least one internal wall comprises at least one hole;
an air valve located on an external surface of said crashable inflatable.

2. The crashable inflatable of claim 1 wherein said at least one bladder comprises two bladders: one coupled to said front side and one coupled to said back side.

3. The crashable inflatable of claim 1 wherein said left side, said right side, and said top side comprise a single integral piece.

4. The crashable inflatable of claim 1 wherein said bottom side and said top side both comprise a fabric, and wherein said bottom side comprises a thicker fabric.

5. The crashable inflatable of claim 4 wherein said bottom side comprises a 14 ounce fabric, and wherein said top side comprises a 7 ounce fabric.

6. The crashable inflatable of claim 1 further comprising a sleeve.

7. The crashable inflatable of claim 1 comprising seven interior walls.

8. The crashable inflatable of claim 1 wherein said at least one interior wall comprises at least one straight interior wall and at least one angled interior wall.

9. An inflatable device comprising:
at least one inflatable membrane for enclosing a gas, said membrane having one or more exterior faces; and
at least one light-emitting device mounted onto said one or more exterior faces,
wherein said at least one light-emitting device includes a switch for remotely activating said light-emitting device.

10. The inflatable device of claim 9 wherein the at least one light-emitting device comprises one or more light-emitting diodes.

11. The inflatable device of claim 9 wherein said at least one light-emitting device includes a wireless receiver for receiving a signal from a wireless transmitter configured to activate said light-emitting device.

12. The inflatable device of claim 9 wherein said at least one light-emitting device is removably secured to said inflatable device.

13. The inflatable device of claim 9, further comprising a sleeve configured to at least partially enclose said inflatable, wherein said at least one light-emitting device is removably mounted to said sleeve.

14. An inflatable device comprising:
at least one inflatable membrane for enclosing a gas, said membrane having one or more exterior faces; and
one or more materials chosen to simulate the exterior of a traffic obstacle are mounted on at least a portion of said one or more exterior faces.

15. The inflatable device of claim 14 wherein said one or more materials chosen to simulate the exterior of a traffic obstacle are chosen from a group consisting of metal, plastic, metal alloy, wood, stone, or concrete.

16. The inflatable device of claim 14 wherein said one or more materials chosen to simulate the exterior of a traffic obstacle are removably mounted to said exterior faces by one or more hook and loop fasteners.

17. The inflatable device of claim 14, further comprising at least one light-emitting device mounted onto said one or more exterior faces.

18. The inflatable device of claim 17 wherein said at least one light-emitting device includes a switch for remotely activating said light-emitting device.

19. The inflatable device of claim 14, further comprising one or more interior walls formed inside the inflatable.

20. The inflatable device of claim 14, wherein said one or more materials chosen to simulate the exterior of a traffic obstacle are arranged on said exterior face in such a manner so as to simulate the appearance of at least one side of a motor vehicle.
